(19) United States
(12) Patent Application Publication
(10) Pub. No.: US 2019/0361251 A1
(43) Pub. Date: Nov. 28, 2019

(54) SEE-THROUGH DISPLAY DEVICE, SYSTEM, PROGRAM, AND INFORMATION PROCESSING METHOD

(71) Applicant: Sony Semiconductor Solutions Corporation, Kanagawa (JP)

(72) Inventors: Takeshi Iwatsu, Kanagawa (JP); Tohru Kadono, Tokyo (JP); Akira Katayama, Tokyo (JP)

(73) Assignee: Sony Semiconductor Solutions Corporation, Kanagawa (JP)

(21) Appl. No.: 16/477,208

(22) PCT Filed: Nov. 28, 2017
(86) PCT No.: PCT/JP2017/042571

§ 371 Date: Jul. 11, 2019

(30) Foreign Application Priority Data
Jan. 18, 2017 (JP) 2017-006816

(51) Int. Cl. G02B 27/02; G06F 3/14; G09G 5/10; G09G 5/38; G06T 19/00; G02B 27/01

(52) U.S. Cl. CPC G02B 27/026; G06F 3/14; G09G 5/10; G02B 2027/0178; G06T 19/006; G02B 27/017; G09G 5/38

(57) ABSTRACT

[Object] To provide a see-through display device, a system, a program, and an information processing method capable of improving safety at the time of use.

[Solving Means] According to one embodiment of the present technology, there is provided a see-through display device including an error detection unit and a display control unit. The error detection unit detects an error. The display control unit controls display of a see-through display on the basis of a detection result of the error detection unit.

### TECHNICAL FIELD

The present technology relates to a see-through display device capable of displaying an image on a see-through display, a system including the see-through display device, and an information processing method and program related to control of the see-through display device.

### BACKGROUND ART

A see-through display device is a display device capable of displaying an image on a see-through (transmission type) display, and in recent years, a glasses-type display device has been in widespread use. For the operation of the see-through display device, a controller or a sensor installed in the see-through display device is used (refer to Patent Literature 1). A see-through display device that adjusts a display image according to the surrounding environment or the like and secures the field of view of the user in order to superimpose an image on the field of view of the user has been developed.

For example, Patent Literature 2 discloses a head mounted display capable of superimposing an obstacle existing around the user on the display to induce danger avoidance. In addition, Patent Literature 3 discloses a head mounted display capable of measuring the distance to an external obstacle with a proximity sensor and physically dismounting the display in front of the eyes when the system is evaluated to be dangerous.

Furthermore, Patent Literature 4 discloses a head mounted display capable of measuring the distance to an obstacle existing around the user with a proximity sensor and changing the position of the display in front of the eyes when the system detects an approach or contact.

### CITATION LIST

### Patent Literature

Patent Literature 1: Japanese Patent Application Laid-open No. 2013-195867

Patent Literature 2: Japanese Patent Application Laid-open No. 2013-257716

Patent Literature 3: Japanese Patent Application Laid-open No. 2010-141453

Patent Literature 4: Japanese Patent Application Laid-open No. 2004-233948

### DISCLOSURE OF INVENTION

### Technical Problem

However, in the configuration in which the operation is performed by the sensor using a sensor or the like as in Patent Literature 1, since the operation is performed according to the user's intention, it is not possible to avoid the danger that the user cannot recognize the abnormality. In addition, in the configuration in which an obstacle existing around the user is detected by a sensor as in Patent Literatures 2 to 4, it is not possible to detect a danger other than the obstacle.

In view of the circumstances as described above, an object of the present technology is to provide a see-through display device, a system, a program, and an information processing method capable of improving safety at the time of use.

### Solution to Problem

In order to achieve the above object, there is provided a see-through display device according to one aspect of the present technology including: an error detection unit; and a display control unit.

The error detection unit detects an error.

The display control unit controls display of a see-through display on the basis of a detection result of the error detection unit.

According to this configuration, since the display control unit controls the display of the see-through display on the basis of the error detected by the error detection unit, it is possible to secure a user's field of view, present an error message according to the occurrence of the error, and the like.

The error detection unit may detect a communication error between the see-through display device and an outside.

The error detection unit may detect an error that has occurred in a module included in firmware.

The error detection unit may detect a communication error between a plurality of modules included in firmware.

The error detection unit may detect an error of hardware.

The error detection unit may detect an error on an application.

The error detection unit may detect a communication error between an application and firmware.

The error detection unit may determine a level of the error, and the display control unit may control the display of the see-through display on the basis of the level of the error determined by the error detection unit.

The error detection unit may adjust a luminance of the see-through display on the basis of the level of the error determined by the error detection unit.

The error detection unit may adjust a transmittance of a light control element included in the see-through display on the basis of the level of the error determined by the error detection unit.

The error detection unit may adjust at least one of a position and a size of a displayed image on the see-through display on the basis of the level of the error determined by the error detection unit.

The see-through display device may include a see-through display mounted on a user's head and arranged in front of user's eyes.

The see-through display device may be installed in a car or a motorcycle.

In order to achieve the above object, there is provided a system according to one aspect of the present technology including: a see-through display device; and an information processing device, the system including: an error detection unit; and a display control unit.

The error detection unit detects an error.

The display control unit controls display of the see-through display on the basis of a detection result of the error detection unit.

The error detection unit may detect a communication error between the see-through display device and the information processing device.

The error detection unit may detect a communication error between an application operating on the see-through display device and an application operating on the information processing device.

The error detection unit may detect a communication error between firmware of the see-through display device and a library of the information processing device.

In order to achieve the above object, there is provided a system according to one aspect of the present technology including: a see-through display device including a see-through display; a first information processing device connected to the see-through display device; and a second information processing device connected to the first information processing device, the system including: an error detection unit; and a display control unit.

The error detection unit detects an error.

The display control unit controls display of the see-through display on the basis of a detection result of the error detection unit.

In order to achieve the above object, there is provided a program according to one aspect of the present technology causing an information processing device to function as: an error detection unit; and a display control unit.

The error detection unit detects an error.

The display control unit controls display of the see-through display on the basis of a detection result of the error detection unit.

In order to achieve the above object, there is provided an information processing method according to one aspect of the present technology including: in an error detection unit, detecting an error; and in a display control unit, controlling display of a see-through display on the basis of a detection result of the error detection unit.

### Advantageous Effects of Invention

As described above, according to the present technology, it is possible to provide a see-through display device, a system, a program, and an information processing method capable of improving safety at the time of use. In addition, the effect described herein is not necessarily limited and may be any effect described in the present disclosure.

### BRIEF DESCRIPTION OF DRAWINGS

FIG. 1 is a schematic view of a system according to a first embodiment of the present technology.

FIG. 2 is a block diagram illustrating a functional configuration of the same system.

FIG. 3 is a sequence diagram illustrating operations of the same system.

FIG. 4 is a schematic view of a system according to a second embodiment of the present technology.

FIG. 5 is a block diagram illustrating a functional configuration of the same system.

FIG. 6 is a sequence diagram illustrating operations of the same system.

FIG. 7 is a schematic view of a system according to a third embodiment of the present technology.

FIG. 8 is a block diagram illustrating a functional configuration of the same system.

FIG. 9 is a sequence diagram illustrating operations of the same system.

FIG. 10 is a schematic view of a system according to a fourth embodiment of the present technology.

FIG. 11 is a block diagram illustrating a functional configuration of the same system.

FIG. 12 is a sequence diagram illustrating operations of the same system.

FIG. 13 is a block diagram illustrating a hardware configuration of a see-through display device included in a system according to an embodiment of the present technology.

FIG. 14 is a schematic view illustrating a software package of the same system.

FIG. 15 is a schematic view illustrating modules included in firmware of a see-through display device included in the same system.

FIG. 16 is a schematic view illustrating a hierarchy of modules included in firmware of a see-through display device included in the same system.

FIG. 17 is a block diagram illustrating a functional configuration of the same system.

FIG. 18 is a flowchart illustrating operations of the same system.

FIG. 19 is a sequence diagram illustrating operations of the same system.

FIG. 20 is a sequence diagram illustrating operations of the same system.

FIG. 21 is a sequence diagram illustrating operations of the same system.

FIG. 22 is a sequence diagram illustrating operations of the same system.

FIG. 23 is a sequence diagram illustrating operations of the same system.

FIG. 24 is a sequence diagram illustrating operations of the same system.

FIG. 25 is a sequence diagram illustrating operations of the same system.

FIG. 26 is a block diagram illustrating a hardware configuration of devices constituting the same system.

### MODE(S) FOR CARRYING OUT THE INVENTION

Hereinafter, preferred embodiments of the present disclosure will be described in detail with reference to the accompanying drawings. Note that the, in the present specification and the drawings, components having substantially the same functional configuration will be denoted by the same reference numerals, and redundant description will be omitted.

Note that the description will be made in the following order.

1. System Configuration

2. Hardware Configuration of See-Through Display Device

3. Software Package

4. Functional Configuration and Operations of System

5. Specific Processes of System

6. Operation Scenario of System

7. Hardware Configuration

8. Supplement

(1. System Configuration)

A system according to the present embodiment can be realized by any of the following four embodiments.

<1.1 See-Through Display Device Unit>

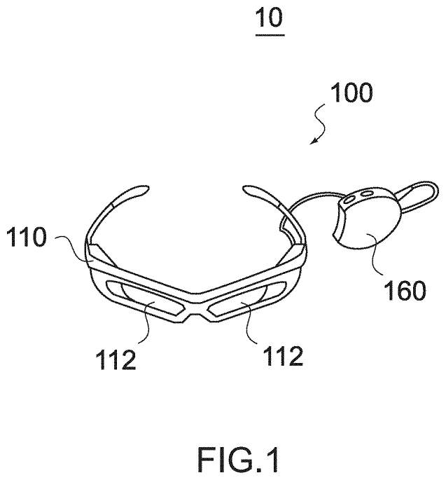

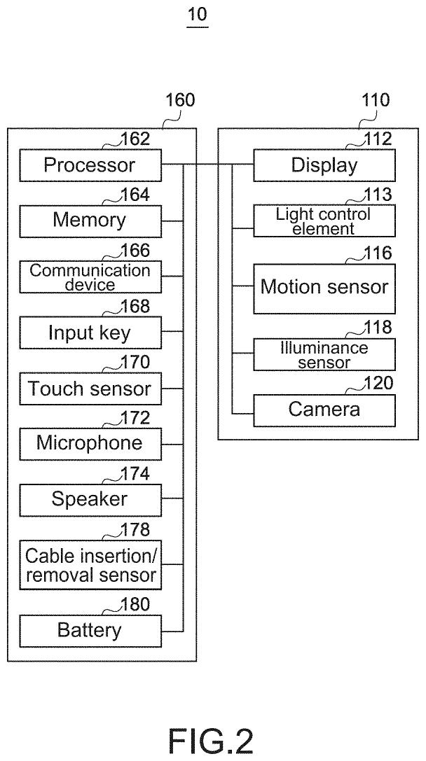

FIG. 1 is a diagram illustrating a schematic configuration of a system 10 according to a first embodiment, and FIG. 2 is a block diagram illustrating a schematic functional configuration of the system 10. As illustrated in FIGS. 1 and 2, system 10 includes a see-through display device 100.

[See-Through Display Device]

The see-through display device 100 includes a display unit 110 and a control unit 160. The display unit 110 has, for example, a glasses-type housing and is mounted on the head of a user (observer). The control unit 160 is connected to the display unit 110 by a cable.

The display unit 110 includes a display 112, as illustrated in FIG. 1. The display 112 is configured with a light guide plate having light transparency and a light source for emitting image display light to the light guide plate in accordance with the control of the control unit 160. The light incident from the real space and transmitted through the light guide plate and the image display light guided from the light source by the light guide plate are incident on the user's eyes. Thus, the user wearing the display unit 110 can perceive an image superimposed on the real space. A light control element 113 adjusts a transmission amount of light transmitted from the real space through the display 112 in accordance with the control of the control unit 160. Note that, a technique as described in, for example, JP-A 4776285 may be used for the configuration for emitting image display light from the light source via the light guide plate. The display unit 110 may further include an optical system (not illustrated) for such a configuration.

Furthermore, the display unit 110 may include a motion sensor 116, an illuminance sensor 118 and a camera 120, as illustrated in FIG. 2. The motion sensor 116 includes, for example, a 3-axis acceleration sensor, a 3-axis gyro sensor, and a 3-axis geomagnetic sensor. The attitude and movement (displacement and rotation) of the display unit 110 can be specified on the basis of the acceleration, angular velocity, and orientation of the display unit 110 detected by these sensors. The illuminance sensor 118 detects an illuminance of the light incident on the display unit 110. The camera 120 captures an image of the real space. The image captured by the camera 120 is, for example, treated as an image corresponding to the field of view of the user in the real space.

The control unit 160 includes a processor 162, a memory 164, a communication device 166, an input key 168, a touch sensor 170, a microphone 172, a speaker 174, a cable insertion/removal sensor 178, and a battery 180. The processor 162 realizes various functions by operating in accordance with programs stored in the memory 164. The processor 162 transmits control signals to the display unit 110 by wired communication via a cable and also supplies a power source for the display 112 and the motion sensor 116. In addition, the processor 162 also acquires data output from the motion sensor 116 and the camera 120 included in the display unit 110 and executes processing on the basis of the data.

The memory 164 stores various data for the operations of processor 162. For example, the memory 164 stores a program for the processor 162 to realize various functions. In addition, the memory 164 also temporarily stores the data output from the motion sensor 116 and the camera 120 of the display unit 110. The communication device 166 performs wireless communication with an external device such as a smartphone. For the wireless communication, for example, Bluetooth (registered trademark) or Wi-Fi is used. The input key 168 includes, for example, a back key and a push-to-talk (PTT) key and acquires a user operation on the see-through display device 100. Similarly, the touch sensor 170 acquires a user operation on the see-through display device 100. More specifically, for example, the touch sensor 170 acquires an operation such as tap or swipe by the user.

The microphone 172 converts an audio into an audio signal and provides the audio signal to the processor 162. The speaker 174 outputs the audio in accordance with the control of the processor 162. The cable insertion/removal sensor 178 is a sensor that detects the connection state of the cable that connects the control unit 160 and the display unit 110. For example, the cable insertion/removal sensor 178 can determine a state where the cable is completely connected, a state where the cable is incompletely connected (the cable is not completely connected, but the connection is maintained), and a state where the cable is not connected. The battery 180 supplies power to all of the control unit 160 and the display unit 110.

Note that, in the see-through display device 100, the processor 162, the microphone 172, the speaker 174, the battery 180, and the like are installed in the control unit 160, and the display unit 110 and the control unit 160 are separated and connected by cables, so that the size and weight of the display unit 110 intend to be reduced. Since the control unit 160 is also carried by the user, it is desirable to reduce the size and weight of the control unit 160 if possible.

Note that, in the see-through display device 100, the display unit 110 and the control unit 160 may be configured integrally. In addition, the see-through display device 100 is not limited to the glasses-type display device as illustrated in FIG. 1, but the see-through display device 100 may be a display device installed in the vicinity of the windshield of a car or in the vicinity of the steering wheel of a motorcycle.

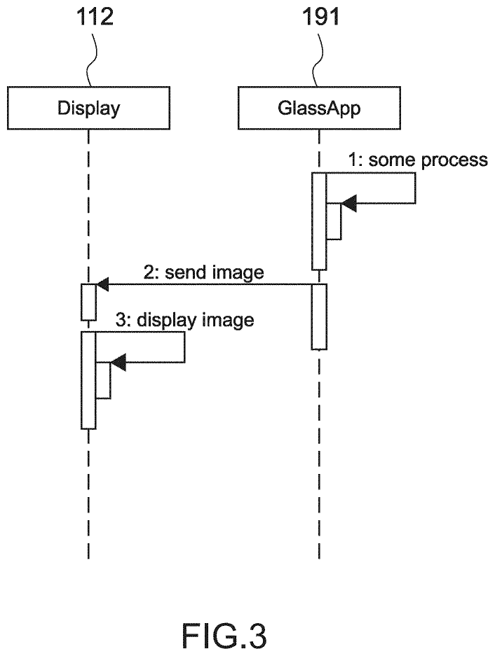

FIG. 3 is a sequence diagram illustrating operations of the system 10. As illustrated in the figure, in the see-through display device 100, an image transmitted from a glass application (GlassApp) 191 is supplied to the display 112 (2: send image) and displayed on the display 112. The glass application 191 is an application operating on the see-through display device 100, and the details will be described later.

<1.2 See-Through Display Device and Smartphone>

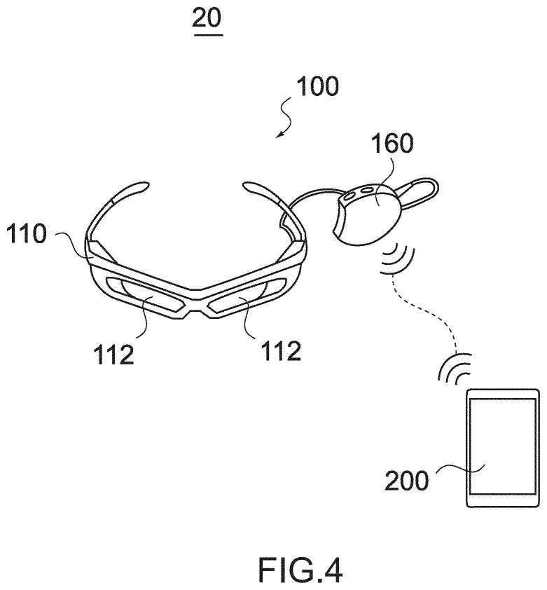

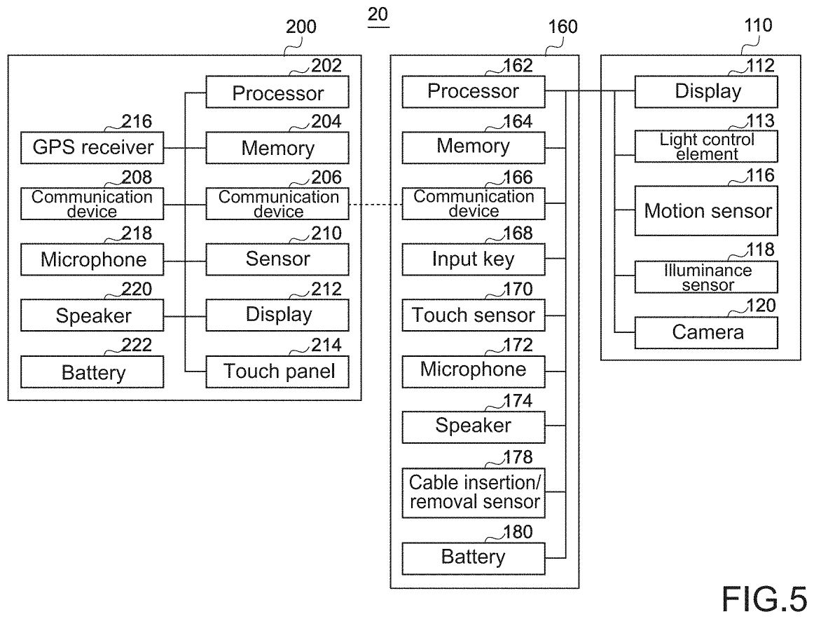

FIG. 4 is a diagram illustrating a schematic configuration of a system 20 according to the second embodiment, and FIG. 5 is a block diagram illustrating a schematic functional configuration of the system 20. As illustrated in FIGS. 4 and 5, the system 20 includes a see-through display device 100 and a smartphone 200. Note that the smartphone 200 may be a PC or the like.

[See-Through Display Device]

The see-through display device 100 has the same configuration as that of the first embodiment except that the communication device 166 is configured to be capable of executing communication with the smartphone 200 by Bluetooth (registered trademark), Wi-Fi, or the like.

[Smartphone]

The smartphone 200 includes a processor 202, a memory 204, communication devices 206 and 208, a sensor 210, a display 212, a touch panel 214, a global positioning system (GPS) receiver 216, a microphone 218, a speaker 220, and a battery 222. The processor 202 realizes various functions by operating in accordance with a program stored in the memory 204. When the processor 202 cooperates with the processor 162 included in the control unit 160 of the see-through display device 100 to realize various functions, the control unit 160 can be made smaller and lighter. The memory 204 stores various data for the operations of the smartphone 200. For example, the memory 204 stores a program for the processor 202 to realize various functions. In addition, the memory 204 temporarily or continuously stores data acquired by the sensor 210 or the GPS receiver 216 and data transmitted to and received from the see-through display device 100.

The communication device 206 performs wireless communication using Bluetooth (registered trademark), Wi-Fi, or the like with the communication device 166 included in the control unit 160 of the see-through display device 100. The sensor 210 includes, for example, an acceleration sensor, an angular velocity sensor, a geomagnetic sensor, or an illuminance sensor and detects various states of the smartphone 200. The display 212 displays various images in accordance with the control of the processor 202. The touch panel 214 is arranged on the display 212 and acquires a touch operation on the display 212 by the user. The GPS receiver 216 receives GPS signals for measuring the latitude, longitude, and altitude of the smartphone 200. The microphone 218 converts an audio into an audio signals and provides the audio signal to the processor 202. The speaker 220 outputs the audio in accordance with the control of the processor 202. The battery 222 supplies power to the entire smartphone 200.

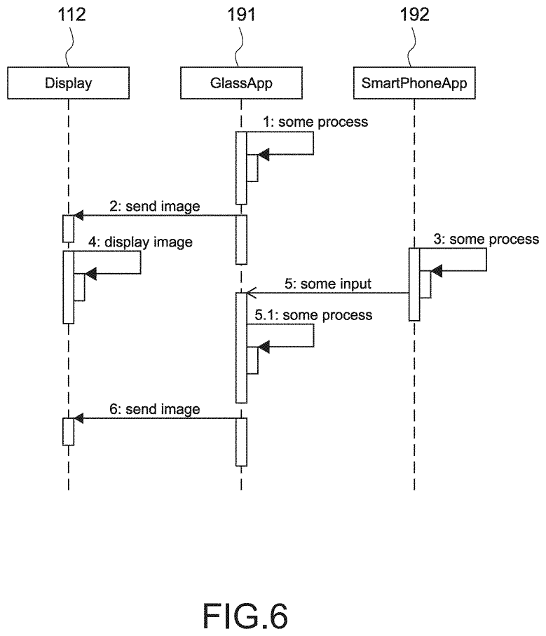

FIG. 6 is a sequence diagram illustrating operations of the system 20. As illustrated in the figure, in the see-through display device 100, the image transmitted from the glass application 191 is supplied to the display 112 (2: send image) and displayed on the display 112. In addition, a predetermined input is executed from a smartphone application (SmartPhoneApp) 192 to the glass application 191 (5: some input), and the image transmitted from the glass application 191 is supplied to the display 112 on the basis of the predetermined input (6: send image) to be displayed on the display 112. The smartphone application 192 is an application operating on the smartphone 200, and the details will be described later.

<1.3 See-Through Display Device and Server>

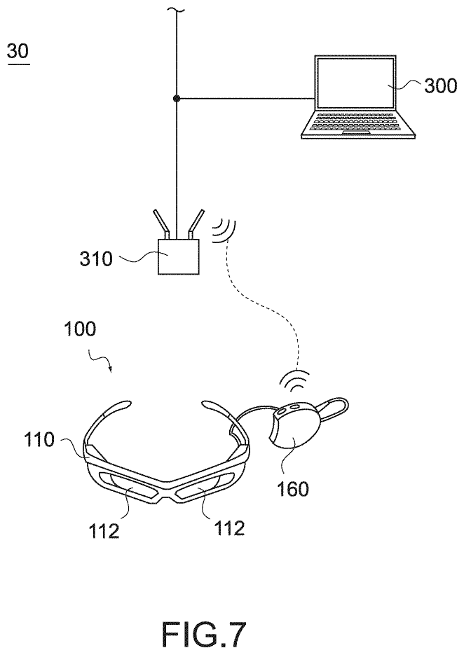

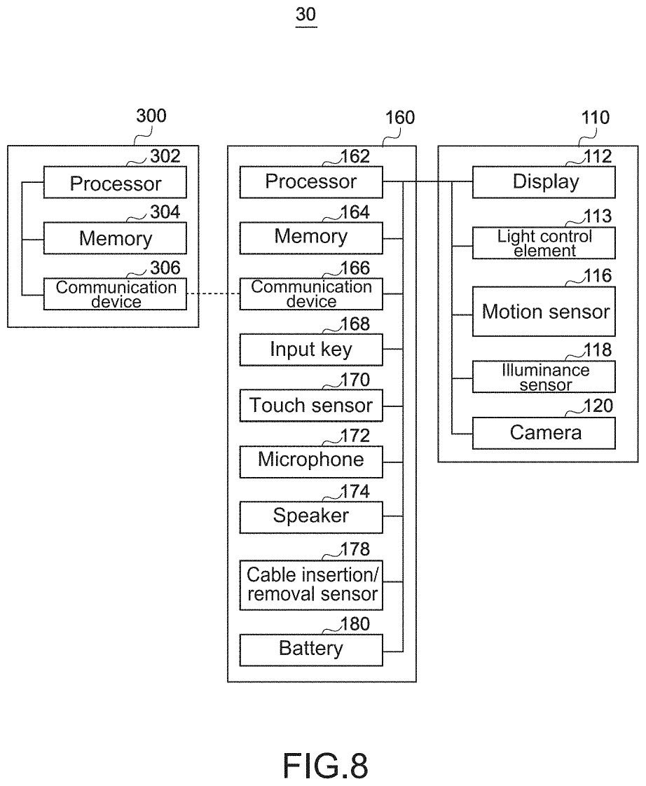

FIG. 7 is a diagram illustrating a schematic configuration of a system 30 according to a third embodiment, and FIG. 8 is a block diagram illustrating a schematic functional configuration of the system 30. As illustrated in FIGS. 7 and 8, the system 30 includes a see-through display device 100 and a server 300. The see-through display device 100 and the server 300 are connected directly via a communication device 310 or via a computer network such as the Internet.

[See-Through Display Device]

The see-through display device 100 has the same configuration as that of the first embodiment except that the communication device 166 is configured to be capable of executing communication with the server 300 by Bluetooth (registered trademark), Wi-Fi, a mobile phone line, or the like.

[Server]

The server 300 includes a processor 302, a memory 304 and a communication device 306. Note that the server 300 may be realized, for example, by cooperation of a plurality of server devices on a network, but herein, in order to simplify the description, the server 300 will be described as a single virtual device. The processor 302 realizes various functions by operating in accordance with a program stored in the memory 304. The processor 302 of the server 300 executes various information processing in response to the request received from, for example, the see-through display device 100 and transmits the result to the see-through display device 100. The memory 304 stores various data for the operations of the server 300. For example, the memory 304 stores a program for the processor 302 to realize various functions. Furthermore, the memory 304 may temporarily or continuously store data uploaded from the see-through display device 100. The communication device 306 is connected to the communication device 166 included in the control unit 160 of the see-through display device 100 via a computer network or the like and performs communication with the communication device 166.

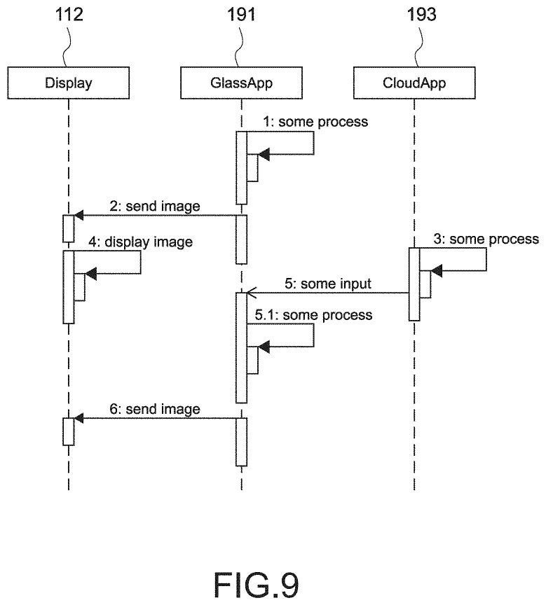

FIG. 9 is a sequence diagram illustrating operations of the system 30. As illustrated in the figure, in the see-through display device 100, the image transmitted from the glass application 191 is supplied to the display 112 (2: send image) and displayed on the display 112. In addition, a predetermined input is executed from the cloud application (CloudApp) 193 to the glass application 191 (5: some input), and the image transmitted from the glass application 191 is supplied to the display 112 on the basis of the predetermined input (6: send image) to be displayed on the display 112. The cloud application 193 is an application operating on the server 300, and the details will be described later.

<1.4 See-Through Display Device, Smartphone, and Server>

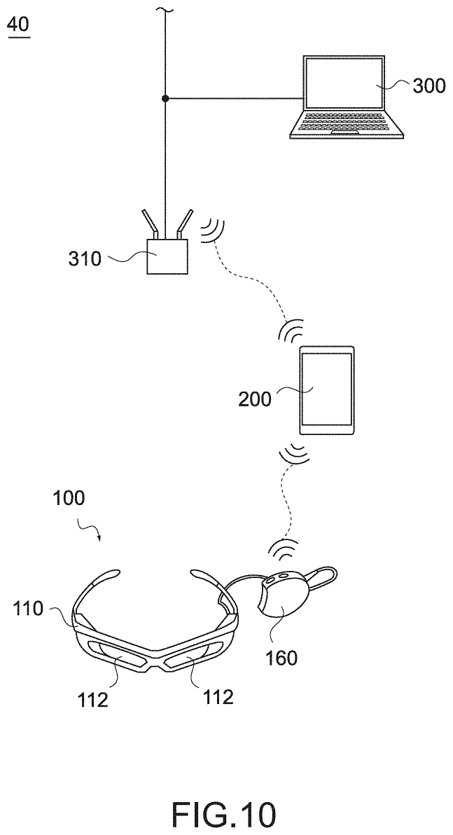

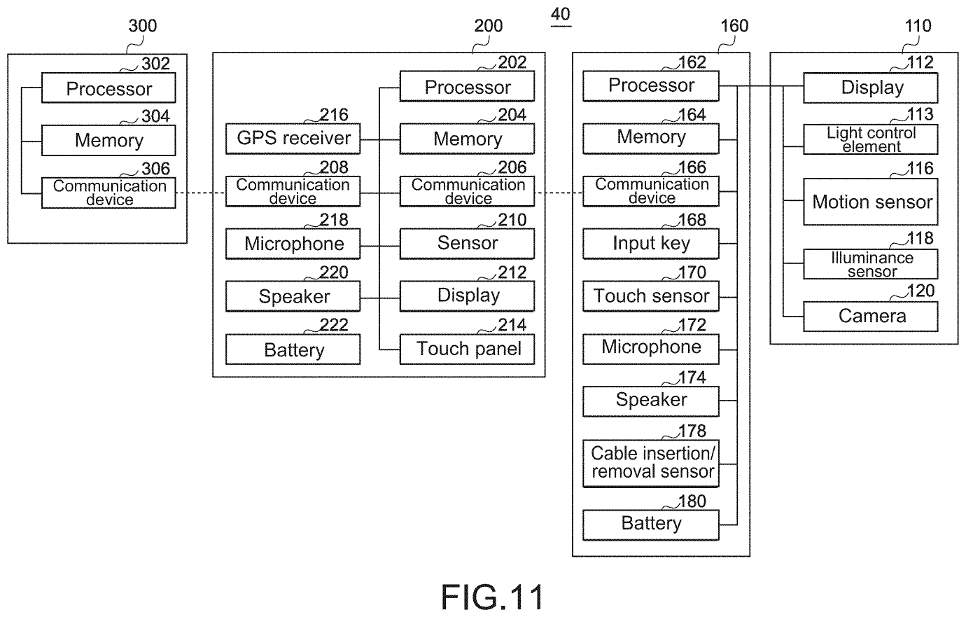

FIG. 10 is a diagram illustrating a schematic configuration of a system 40 according to the fourth embodiment, and FIG. 11 is a block diagram illustrating a schematic functional configuration of the system 40. As illustrated in FIGS. 10 and 11, the system 40 includes a see-through display device 100, a smartphone 200, and a server 300. The see-through display device 100 and the smartphone 200 are connected by wireless communication or the like, and the smartphone 200 and the server 300 are connected directly via the communication device 310 or via a computer network such as the Internet.

[See-Through Display Device]

The see-through display device 100 has the same configuration as that of the first embodiment except that the communication device 166 is configured to be capable of executing communication with the smartphone 200 by Bluetooth (registered trademark), Wi-Fi, or the like.

[Smartphone]

The smartphone 200 has the same configuration as that of the second embodiment except that the communication device 208 is configured to be capable of executing communication with the server 300 by Bluetooth (registered trademark), Wi-Fi, a cellular phone line, or the like. Note that the smartphone 200 may be a PC or the like.

[Server]

The server 300 includes a processor 302, a memory 304 and a communication device 306. Note that the server 300 may be realized, for example, by cooperation of a plurality of server devices on a network, but herein, in order to simplify the description, the server 300 will be described as a single virtual device. The processor 302 realizes various functions by operating in accordance with a program stored in the memory 304. The processor 302 of the server 300 executes various information processing in response to the request received from, for example, the smartphone 200 and transmits the result to the smartphone 200. The memory 304 stores various data for the operations of the server 300. For example, the memory 304 stores a program for the processor 302 to realize various functions. Furthermore, the memory 304 may temporarily or continuously store data uploaded from the smartphone 200. The communication device 306 is connected to the communication device 208 included in the smartphone 200 via a computer network or the like, and performs communication with the communication device 208.

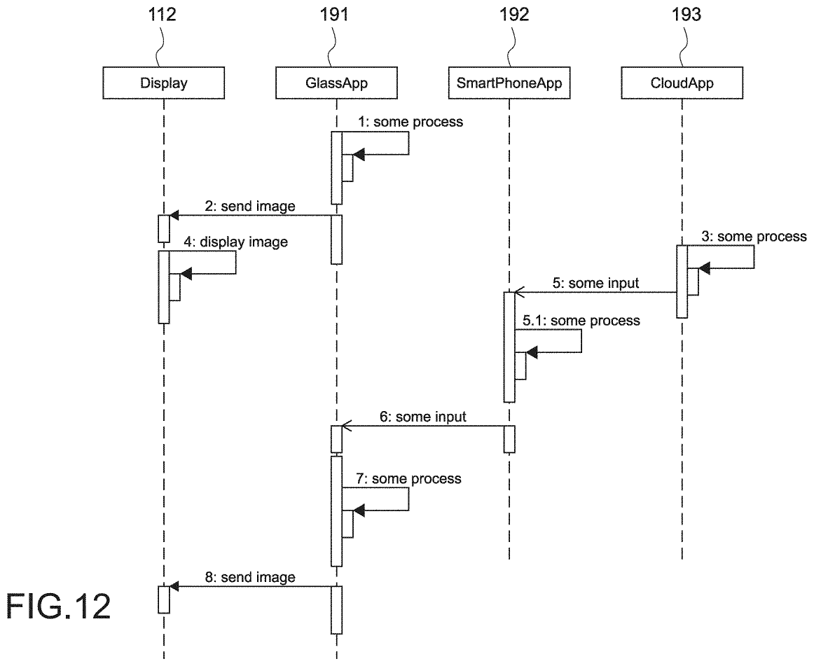

FIG. 12 is a sequence diagram illustrating operations of the system 40. As illustrated in the figure, in the see-through display device 100, the image transmitted from the glass application 191 is supplied to the display 112 (2: send image) and displayed on the display 112. In addition, a predetermined input is executed from the cloud application 193 to the smartphone application 192 (5: some input), and on the basis of the predetermined input, a predetermined input is executed from the smartphone application 192 to the glass application 191 (6: some input). The image transmitted from the glass application 191 is supplied to the display 112 on the basis of the predetermined input (8: send image) and displayed on the display 112.

The system according to the present embodiment may be any of the systems according to the first to fourth embodiments. Hereinafter, the system according to the present embodiment is referred to as a system 1000.

(2. Hardware Configuration of See-Through Display Device)

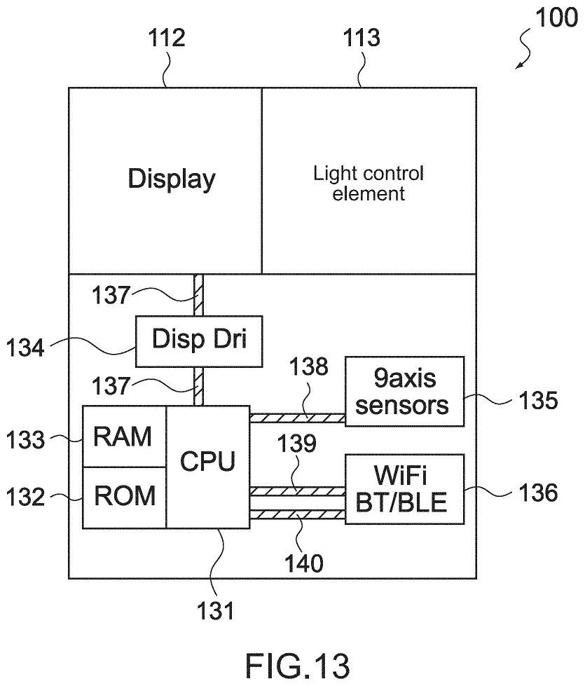

FIG. 13 is a schematic view illustrating a detailed hardware configuration of the see-through display device 100 according to the first to fourth embodiments. As illustrated in the figure, the see-through display device 100 includes a CPU 131, a ROM 132, a RAM 133, a display driver 134, a 9-axis sensor 135, and a WiFi/BT BLE device 136 as hardware configurations. The functional configuration in each of the above-described embodiments is realized by these hardware configurations.

The CPU 131 functions as an calculation processing unit and a control unit and controls the overall or some of operations of the see-through display device 100 according to various programs recorded in the ROM 132, the RAM 133, and the like. The ROM 132 stores the programs, calculation parameters, and the like used by the CPU 131. The RAM 133 primarily stores the programs used in the execution of the CPU 131, parameters that appropriately change in the execution, and the like.

The display driver 134 is connected to the CPU 131 and the display 112 via the bus 137 and drives the display 112 on the basis of the control by the CPU 131 to display an image on the display. The 9-axis sensor 135 includes a 3-axis acceleration sensor, a 3-axis gyro sensor, and a 3-axis geomagnetic sensor and detects the orientation, acceleration, and the like of the see-through display device 100. The 9-axis sensor 135 is connected to the CPU 131 via an IZC bus 138 and supplies a detection result to the CPU 131. The WiFi/BT BLE device 136 is connected to the CPU 131 via a UART bus 139 and an SDIO bus 140 and performs communication using WiFi, Bluetooth (registered trademark) (BT) or Bluetooth (registered trademark) Low Energy (BLE) on the basis of the control by the CPU 131.

(3. Software Package)

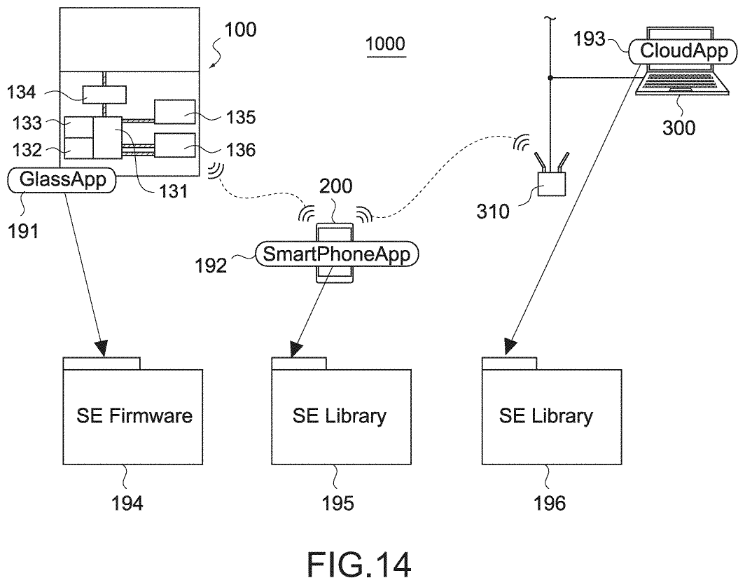

FIG. 14 is a schematic diagram illustrating a software package of the system 1000. As illustrated in the figure, a glass application (Glass App) 191 operates on the see-through display device 100. The glass application 191 is configured by using smart eyeglass (SE) firmware 194.

In addition, a smartphone application (SmartPhone App) 192 operates on the smartphone 200, and a cloud application (Cloud App) 193 operates on the server 300. The smartphone application 192 is configured by using an SE library (Library) 195, and the cloud application 193 is configured by using an SE library 196.

The functions of the see-through display device 100 can be used by each application in cooperation with the SE firmware 194, the SE library 195, and the SE library 196.

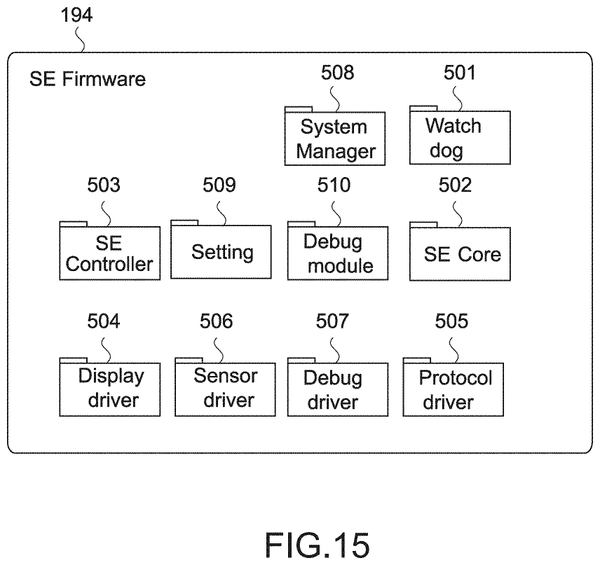

FIG. 15 is a schematic view illustrating modules constituting the SE firmware 194. As illustrated in the figure, the SE firmware 194 includes each module of a watchdog 501, an SE core 502, an SE controller 503, a display driver 504, a protocol driver 505, a sensor driver 506, a debug driver 507, a system manager 508, setting 509 and a debug module 510. Details of each module will be described later.

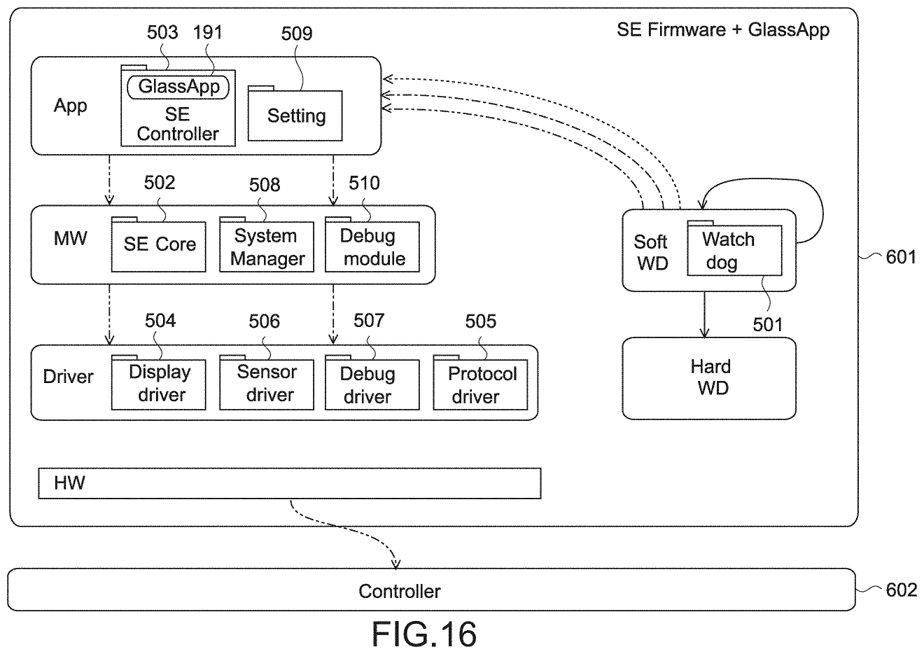

FIG. 16 is a schematic view illustrating a hierarchy of each module. As illustrated in the figure, each module is included in the SE firmware and glass application (SE Firmware+GlassApp) 601. The controller 602 is realized by one or both of the smartphone application 192 and the cloud application 193. The watchdog 501 is included in a software watchdog (Soft WD), and the SE controller 503 and the setting 509 are included in application software (App). A glass application (GlassApp) 191 can be realized by implementing an application on the SE controller 503.

In addition, the SE core 502, the system manager 508 and the debug driver 507 are included in middleware (MW), and the display driver 504, the sensor driver 506, the debug driver 507, and the protocol driver 505 are included in the driver.

Solid line arrows in FIG. 16 indicate the transmission of an abnormality detection trigger in processing of a certain period. In addition, broken line arrows are processes of the evaluation of the abnormality of application and the application restoration and the application switching at the time of the abnormality. The one-dot dashed line arrows are processes of the evaluation of the abnormality of the entire see-through display device 100, the restoration at the time of the abnormality, and the like. The dashed double-dotted arrows are processes of the evaluation of the abnormality of the entire system including the controller 602 via the network, the system restoration at the time of the abnormality, and the like.

(4. Functional Configuration and Operations of System)

The functional configuration and operations of the system 1000 according to the present embodiment will be described.

<4-1. Error Detection and Display Control of Display>

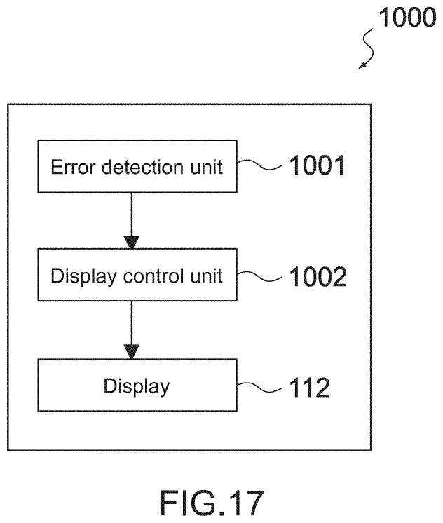

FIG. 17 is a block diagram illustrating a functional configuration of the system 1000. As illustrated in the figure, the system 1000 includes an error detection unit 1001, a display control unit 1002, and a display 112.

The error detection unit 1001 detects an error that occurs in the system 1000. Although the details of the errors detected by the error detection unit 1001 will be described later, there are errors on software or errors on hardware in each of the above-described modules, communication errors between the modules, errors on the application, communication errors between the application and the firmware, communication errors between the applications, and errors between the devices. If the error is detected, the error detection unit 1001 supplies a detection result to the display control unit 1002.

The configuration functioning as the error detection unit 1001 is the watchdog 501, the SE core 502, the SE controller 503, the display driver 504, the protocol driver 505, the sensor driver 506, the SE library 195, the SE library 196, the smartphone application 192, the cloud application 193, or the system of the platform of the smartphone 200 or the server 300.

The display control unit 1002 controls the display of the display 112 on the basis of the detection result of the error by the error detection unit 1001. The control of the display by the display control unit 1002 is not particularly limited, but it is desirable to change the display so that the display on the display 112 does not interfere with the user's field of view. Specifically, if the detection result of the error is supplied from the error detection unit 1001, the display control unit 1002 performs control of erasing the displayed image on the display 112, erasing the light control element, displaying an error message, shifting the position of the displayed image, reducing the displayed image, and the like.

In addition to this, the display control unit 1002 may arrange the displayed image in the peripheral edge portion of the display 112 as described in, for example, WO 2013/190766. In addition, when the display control unit 1002 displays an error message on the display 112, as described in WO 2014/128809, the display control unit 1002 may detect the motion of the user and display the error message at a highly visible position.

The configuration functioning as the display control unit 1002 is the SE firmware 194, and more specifically, the watchdog 501, the SE core 502, the SE controller 503, the display driver 504, the protocol driver 505, or the sensor driver 506.

Accordingly, when an error occurs in the system 1000, the user's field of view is secured, and the danger of the user is avoided. In addition, since the process is performed in a hierarchy relatively close to hardware such as the SE firmware 194, even if a freeze of an application or the like occurs, the display control process is not interfered with, and the security is high.

<4-2. Display Control of Display According to Error Level>

The error detection unit 1001 may determine the level of the error as well as the detection of the error. The levels may be, for example, four levels of levels 0 to 3, and an example is illustrated below.

Level 0: There is no danger for the user

Level 1: The degree of danger given to the user is very high, and a very long time is taken for restoration

Level 2: The degree of danger given to the user is high to some extent, and some time is taken for restoration

Level 3: The degree of danger given to the user is small, and no time is taken for restoration.

The error detection unit 1001 supplies the level of the error to the display control unit 1002. If the level of the error is supplied from the error detection unit 1001, the display control unit 1002 controls the display of the display 112 on the basis of the level of the error.

The display control unit 1002 may adjust a luminance of the display 112 on the basis of, for example, the level of the error or adjust the transmittance of the light control element included in the display 112. In addition, the display control unit 1002 may adjust at least one of the position and the size on the display 112 on the basis of the level of the error.

Specifically, the display control unit 1002 may perform control of adding a slight change to the display of the display 112 in a case where a degree of danger of the level of error to the user is small and adding a significant change to the display of the display 112 in a case where a degree of danger of the level of error to the user is large. Hereinafter, an example of the display control according to the level of an error is illustrated.

Level 0: Not to change the display

Level 1.a: To erase the displayed image or to stop the operation of the light control element to maximize a brightness

Level 1.b: To erase the displayed image and to display an error message at a position that the display does not interfere with the field of view

Level 2.a: To shift the position of the displayed image to secure the field of view (for example, shift the displayed image down, up, right, or left)

Level 2.b: To reduce the details of the displayed image or not to shift the position of the reduced displayed image (for example, reduction while maintaining the aspect ratio, compression in portrait, compression in landscape, or the like)

Level 3: To reduce the brightness of the display or to reduce the transmittance of the light control element

As described above, when the system 1000 performs controlling the display of the display 112 according to the level of the error, it is possible to realize appropriate display control according to the degree of danger given to the user.

(5. Specific Processing of System)

A specific process of the error detection and display control (fail safe process) of the system 1000 described above will be described.

<5-1 Error Detection and Fail Safe Process>

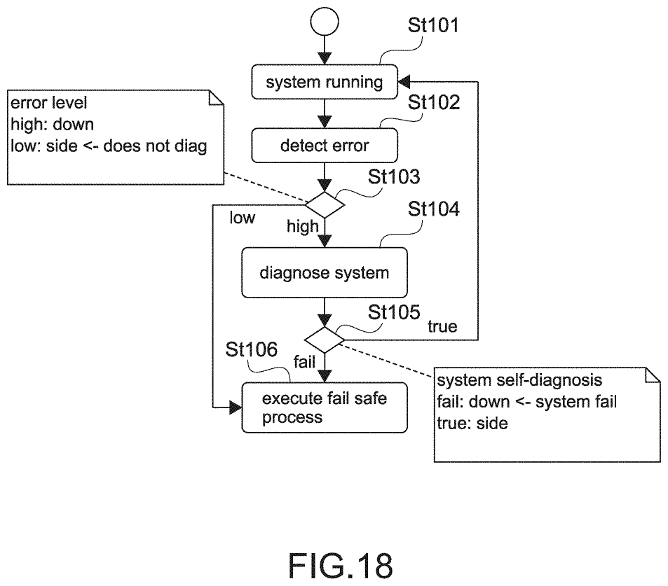

FIG. 18 is a flowchart illustrating a fail safe process of the system 1000.

As illustrated in FIG. 18, if the error detection unit 1001 detects an error (St102) during system running (St101), the height of the error level is determined (St103). In a case where the error level is high (St103: high), the cause investigation process (St104) is executed, and if the cause investigation succeeds (St105: true), the state returns to the running state (St101). When the cause investigation fails (St105: fail), the display control unit 1002 executes a fail safe process (St106). In addition, even in a case where the error level is low (St103: low), the display control unit 1002 executes the fail safe process (St106).

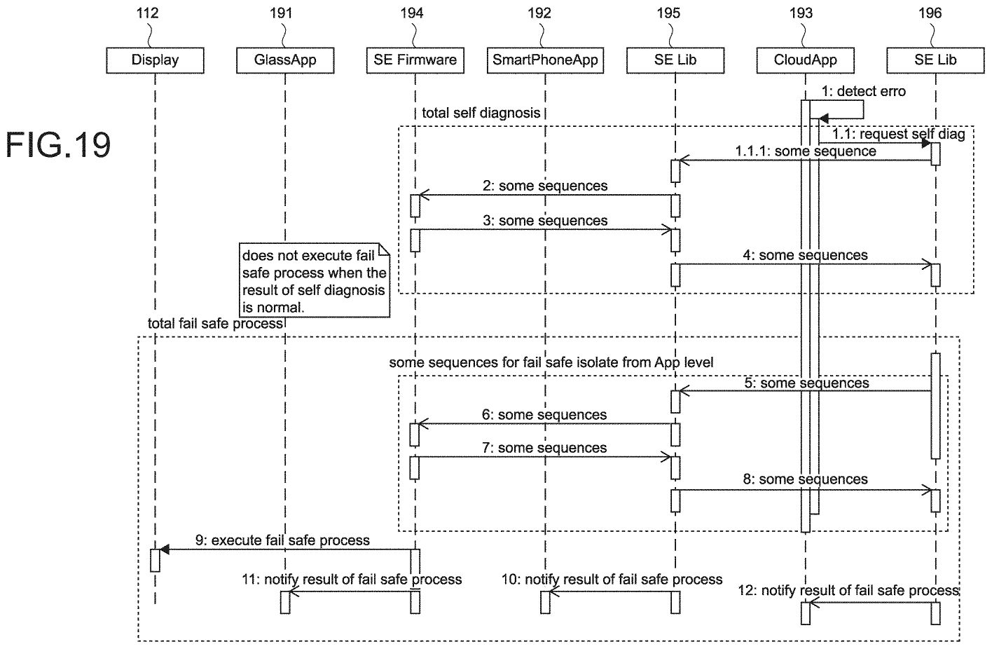

FIG. 19 is a sequence diagram in the case of executing the cause investigation process (St104) and the fail safe process (St105). As illustrated in the figure, if the error detection unit 1001 (in the figure, the cloud application 193 as an example) detects an error (1: detect error), the functions for the cause investigation in the SE firmware 194, SE library 195, and SE library 196 are called (1.1 to 4), and total self diagnosis is performed.

Subsequently, the fail safe functions in the SE firmware 194, the SE library 195, and the SE library 196 are called (5 to 8), and the SE firmware 194 executes the fail safe process (9: execute the fail safe process). After that, execution of the fail safe process is notified to each application (10 to 12).

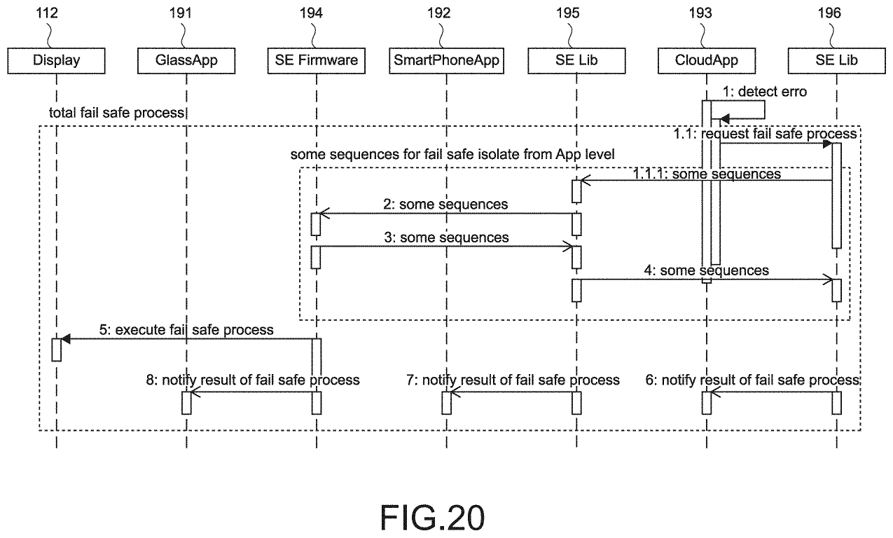

FIG. 20 is a sequence diagram in the case of executing the fail safe process (St105) without executing a cause investigation process (St104). In this case, if the error detection unit 1001 (in the figure, the cloud application 193 as an example) detects an error (1: detect error), the fail safe functions in the SE firmware 194, the SE library 195, and the SE library 196 are called (1.1 to 4), and the SE firmware 194 executes the fail safe process (5: execute the fail safe process). After that, execution of the fail safe process is notified to each application (6 to 8).

<5-2. Error Detection and Fail Safe Process with SE Firmware Alone>

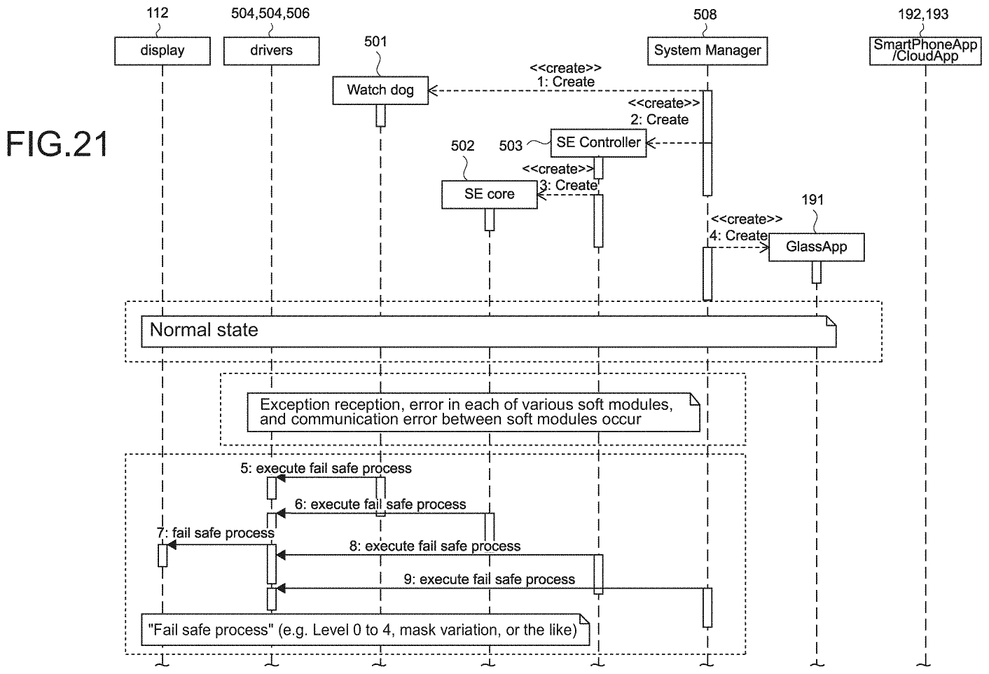

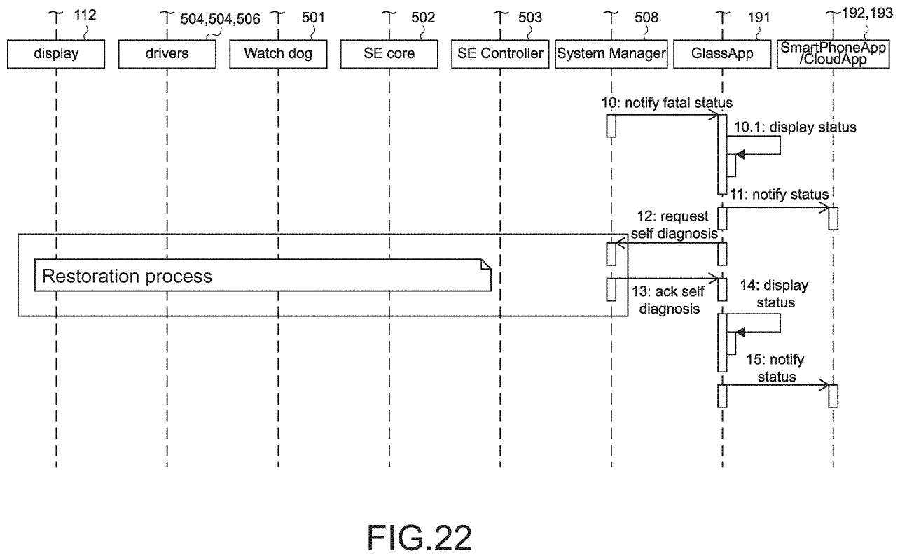

FIG. 21 and FIG. 22 are sequence diagrams in a case where the SE firmware 194 alone performs error detection. Note that FIG. 21 and FIG. 22 divide and illustrate the continuous sequence diagram.

If the SE firmware 194 detects an error in the see-through display device 100 (any of 5 to 9), the fail safe process (7: fail safe process) is executed in the SE firmware 194. Furthermore, the SE firmware 194 notifies the status to the glass application 191 (10: notify fatal status), and notification to the smartphone application 192 and the cloud application 193 (11: notify status) and a restoration process are executed.

<5-3. Error Detection Unit and Fail Safe Process in Smartphone Application or Cloud Application>

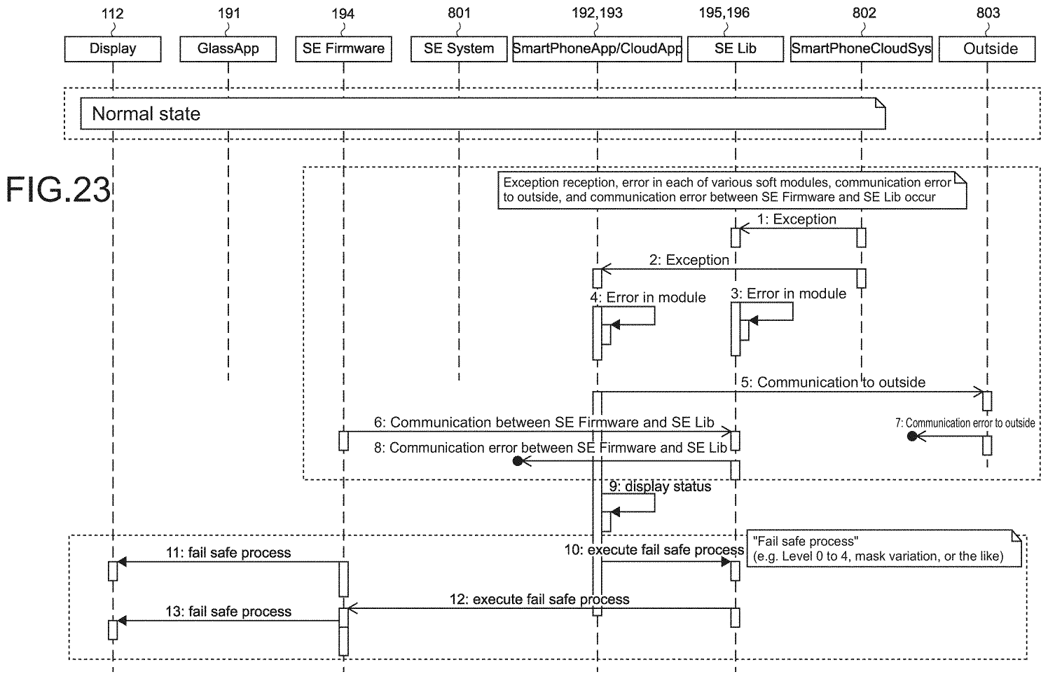

FIG. 23 is a sequence diagram in the case of detecting an error that has occurred between devices or in devices other than the see-through display device 100.

When an error is detected on the smartphone 200 side or the server 300 side (one of 1 to 4), the smartphone application 192 or the cloud application 193 executes the fail safe process with the function of the SE library 195 or the SE library 196 (10 and 12: execute the fail safe process).

In addition, when an error is detected between the SE firmware 194 and the SE library 195 or the SE library 196 (8), the SE firmware 194 executes the fail safe process (11). The status is notified to the smartphone application 192, the cloud application 193, or the external device 803.

<5-4. Specific Example of Error Detection and Fail Safe Process>

As described above, each module, SE library, or application functions as an error detection unit and a display control unit. Hereinafter, specific examples in which each of the module, the SE library, and the application operates as an error detection unit and a display control unit are described.

The watchdog 501 is a module that periodically monitors hard resources and soft modules and detects glass system abnormality, and the watchdog executes freeze detection of the entire software that uses a hard watchdog function.

The watchdog 501 periodically clears a hard watchdog flag, but if the watchdog cannot clear the hard watchdog flag within a certain time, the hard watchdog output is asserted, and the display 112 is turned off by the reset of the display driver 134. After that, system restoration is performed according to the reset of the CPU 131.

The SE core 502 is a module that manages and executes a protocol for display of the display 112 and sensor value processing.

In a case where memory securing due to insufficient memory fails at the time of memory securing in a program that uses dynamic memory securing, the SE core 502 determines that continuous processing is not possible, erases the display on the display 112, and performs a state display that does not interfere with the field of view. Subsequently, the SE core 502 performs the restoration process of the SE core itself, and if the SE core returns to normal, the SE core process is continuously performed.

In addition, in a case where the CPU 131 has a memory management unit, the SE core 502 erases the display on the display 112 by signal notification when the program causes a memory access violation and performs a state display that does not interfere with the field of view. Subsequently, the SE core 502 performs the restoration process of the SE core itself, and if the SE core returns to normal, the SE core process is continuously performed.

In addition, in a case where the SE core 502 receives a command packet that does not conform to the specifications defined by the protocol, the SE core 502 reduces the image being displayed so as to secure the field of view and returns an abnormal packet acknowledgment notice to encourage retransmission of a normal command packet and to encourage the restoration of the system.

In addition, when the SE core 502 detects that the command packet for transmitting a data to be displayed on the display 112 violates the specifications, the SE core 502 lowers a luminance of the image being displayed to secure the field of view and notify the violation of the command packet specification to encourage the retransmission of a normal data and to perform the restoration of the system.

The SE controller 503 is a module that manages the state of the system of the see-through display device 100 and performs a state transition when receiving an event defined for each state.

In a case where the system abnormality is determined due to reception of an event not defined in that state or an event in which defined event processing is not prescribed for an arbitrary state, the SE controller 503 erases the display of the display 112 and performs abnormality processing.

The display driver 504 is a module that performs an operation of the display driver 134 that is hardware.

The display driver 504 periodically reads the register value set at startup. In a case where the setting values become inconsistent, the display driver 504 determines an incorrect state of the display control of the display due to a communication failure caused by a connection failure noise between the CPU 131 and the display driver 134 on hardware and erases the display of the display 112.

In addition, the display driver 504 determines whether or not the values match with each other at the time of reading the same values at the time of changing or after writing the register values for the left/right/up/down shift or the inversion of the display data of the display 112. In a case where the values do not match, the display driver 504 determines an incorrect state of the display control of the display due to a communication failure caused by connection failure noise between the CPU 131 and the display driver 134 on hardware and erases the display on the display 112.

The protocol driver 505 is a module that performs an operation of a device of a hardware communication path for protocol transmission and reception.

In a case where there is no response from the UART device at the time of protocol transmission, the protocol driver 505 determines that, since the protocol transmission to the see-through display device 100 cannot be received by the see-through display device 100 side or the protocol transmission from the see-through display device 100 cannot be performed, the update of 112 cannot be performed, and the protocol driver 505 turns off the display 112.

The sensor driver 506 is a module that performs operations of various sensors such as the 9-axis sensor 135.

In a case where an I2C command error occurs when the sensor power is turned on for displaying the display 112 on the basis of the sensor value, the sensor driver 506 determines that the sensor cannot be used and displays, on the display 112, a message indicating that the sensor cannot be used.

In addition, when the sensor driver 506 periodically acquires the sensor value and uses the result calculated by an algorithm on the basis of the value for the display of the display 112, in a case where the I2C sensor value notification cannot be received for a predetermined time or more, the sensor driver 506 determines that normal display cannot be performed and displays, on the display 112, a message indicating that normal display cannot be performed.

The SE library 195 and the SE library 196 (hereinafter, referred to as the SE library) are libraries for the application to use the functions of the display of the display of the see-through display device 100 and the function for acquiring the sensor values. In a case where an error occurs in the SE library, the SE library issues a fail safe process request to the SE firmware 194, switches to the display of the display that can secure the field of view and notifies the smartphone application 192 or the cloud application 193 that the display of the display can secure the field of view.

The smartphone application 192 is an application operating on the smartphone 200. In a case where an error occurs in the smartphone application 192, the smartphone application 192 issues a fail safe process request to the SE library 195, and the SE library 195 which received the request issues the fail safe process request to the SE firmware 194, so that the display of the display is switched to such a display that can secure the field of view.

In addition, in a case where the smartphone application 192 detects abnormality in communication between the smartphone application itself and the external service, the smartphone application issues a fail safe process request to the SE library 195, and the SE library 195 that received the request issues the fail safe process request to the SE firmware 194, so that the display of the display is switched to such a display that can secure the field of view.

The cloud application 193 is an application operating on the server 300. When an error has occurred in the cloud application 193, the cloud application 193 issues the fail safe process request to the SE library 196, and the SE library 196 that received the request issues the fail safe process request to the SE firmware 194 to switch to a display that can secure the field of view.

In addition, when the cloud application 193 detects abnormality in the communication between the cloud application itself and the external service, the cloud application issues the fail safe process request to the SE library 196, and the SE library 196 that received the request issues the fail safe process request to the SE firmware 194 to switch to a display that can secure the field of view.

A smartphone cloud system 802 is a system of a smartphone or cloud service platform. In a case where the SE library (SE library 195 or SE library 196) determines that the system configured with the SE library and the SE firmware 194 does not function normally due to an exception reception, the SE library issues a fail safe process request to the SE firmware 194, so that the display of the display is switched to such a display that can secure the field of view. In addition, the SE library notifies the smartphone application 192 or the cloud application 193 that the state has been reached.

(6. Operation Scenario of System)

An operation scenario of the system 1000 according to the present embodiment will be described.

<6-1. Level 0>

In a case where the error detection unit 1001 determines that the detected error level is Level 0 (there is no danger given to the user), the system 1000 executes the following operations.

1: SE controller 503 receives an abnormal event

2: Error processing is performed

3: The system 1000 returns to a normal state

4: (No processing)

<6-2. Processing for Error Level 1>

In a case where the error detection unit 1001 determines that the detected error level is Level 1 (the degree of danger given to the user is very high and a very long time is taken for restoration), the system 1000 executes the following operations.

1: A product of which default of the system 1000 is set to Level 1.a is shipped

2: To set to Level 1.b again because the user wants to display an error

3: The SE core 502 fails to secure necessary memory during processing

4: To be in a condition that error processing in the SE core 502 is performed but the processing cannot be continuously performed.

5: To perform the fail safe process of Level 1.b

6: Restarting of the SE core 502 is performed, and system returns to a normal state by the restoration process

<6-3. Processing for Error Level 2>

In a case where the error detection unit 1001 determines that the level of the detected error is Level 2 (the degree of danger given to the user is high to some extent and some time is taken for restoration), the system 1000 executes the following operations.

1: A product of which default of the system 1000 is set to Level 2.a is shipped.

2: Toe set to Level 2.b because the user wants to display an error.

3: The smartphone application 192 detects an error in the application

4: To perform the fail safe process of Level 2.b

5: The smartphone application 192 performs error processing and returns to a normal state by the restoration process

<6-4. Processing for Error Level 3>

In a case where the error detection unit 1001 determines that the detected error level is Level 3 (the degree of danger given to the user is small and a long time is not taken for restoration), the system 1000 executes the following operations.

1: The cloud application 193 executes the application using an external service

2: The cloud application 193 detects abnormal communication with the external service

3: To execute a fail safe process of Level 3.

4: The communication with the external service is restored, and the process returns to normal processing

<6-5. Processing During Navigation>

When a user wearing a see-through display device approaches a corner of a curve while executing a turn-by-turn navigation application in the see-through display device, if a failure in connection between the see-through display device and the smartphone occurs at the timing when the arrow indicating the traveling direction is displayed large, the arrow remains displayed.

The system 1000 is a system that communicates between the SE firmware 194 and the SE library 195 and detects that communication confirmation packet exchange for confirming a state in which the communication is possible has failed and performs a fail safe process. Accordingly, the arrows are prevented from being displayed.

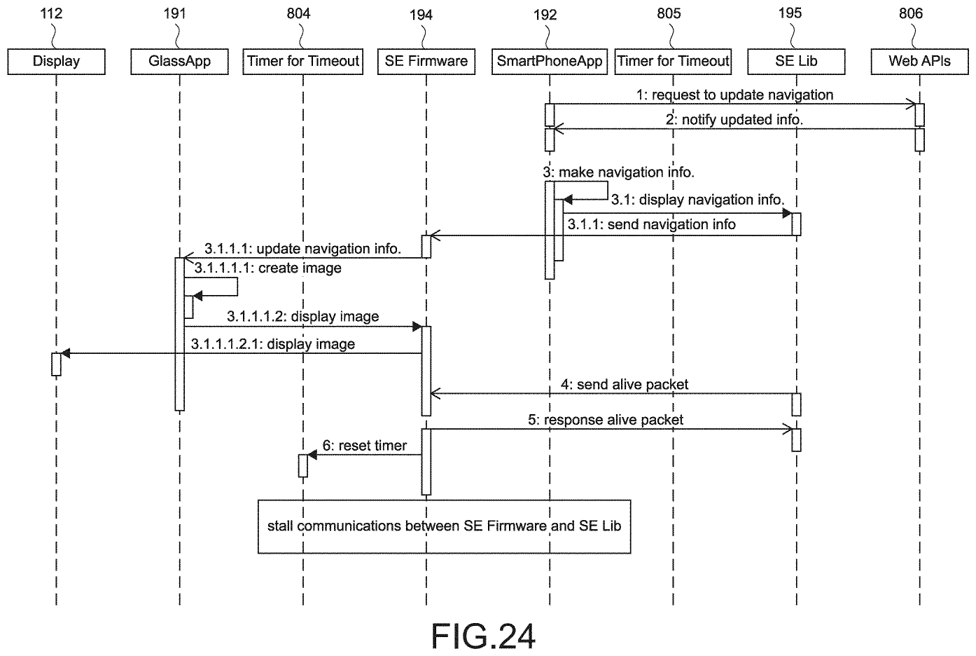

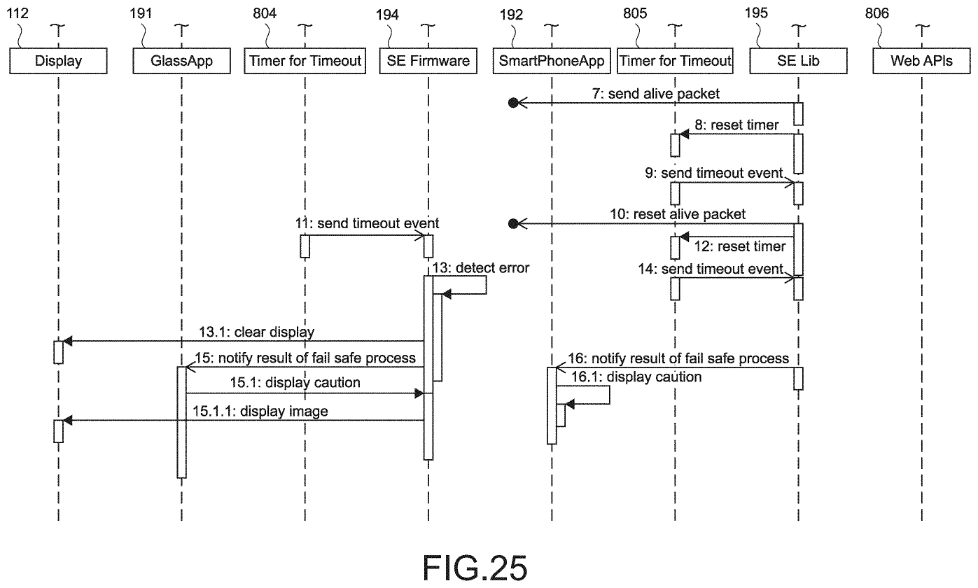

FIGS. 24 and 25 are sequence diagrams in this scenario. Note that FIG. 24 and FIG. 25 divide and illustrate the continuous sequence diagram. As illustrated in the figure, communication (1-3.1) for navigation among the smartphone application 192, the web API 806, and the SE library 195 is performed, and communication (3.1.1.1 to 3.1.1.1.2) for navigation between the SE firmware 194 and the glass application 191 is performed. Furthermore, navigation information is supplied to the display 112 by the SE firmware 194 (3.1.1.1.2.1). If the communication is disrupted as the communication between the SE firmware 194 and the SE library 195 (stall communication), the display is erased (13.1).

<6-6. Display Control by User Operation>

At the time of changing a lane with a motorcycle, in order to safely confirm that there is no following vehicle being directed to the line of sight in the backward right lower right (left), while seeing the display of the speedometer, the blinkers, or the like on the see-through display device 100, the speedometer, the blinkers, or the like is configured so as not to interfere with the field of view.

The see-through display device 100 detects the rotation of the head by the motion sensor 116, and controls the display as any one of the following in a case where the right (left) rotation is detected (line of sight in the backward lower right (left)).

A: To erase the display

B: To make the display thinner

C: To shift the display to the left (right) side

D: To reduce the display to the left (right) side

In A to D, a case where the speed of the motorcycle is high or rapid acceleration can be selected by performing an animation of safer A, and a case where there is room for the speed limit and acceleration is not performed can be selected by performing an animation of D in order to provide the continuity of the display to be easily seen, not to be tired, and to further improve the quality.

<6-7. Display Control by User Operation>

While the speedometer is displayed on the see-through display device 100, the same information is superimposed when the meter of the motorcycle is viewed, so that the display of the display 112 does not interfere with the field of view.

In a state where the speedometer of the motorcycle is displayed on the display 112, when the user turns the head downward to see the speedometer, if the speed of the motorcycle is close to 0, the display is continuously performed, and the display of the navigation map or the like other than the speedometer is performed in a manner that depends on the specification.

In addition, in a case where the speed of the motorcycle is not 0 (during driving) or in a case where acceleration can be detected, since the speedometer is hard to see, the field of view is allowed not to be interfered with by thinning and reducing the glass display and shifting the display position, or the like; and in a case where the acceleration is higher than a certain value (sudden acceleration), erasing of the display on the display 112 or the like is performed.

<6-8. Display Control by Environment>

At the time of displaying the speedometer on the display 112 while traveling on a motorcycle on a sunny day, it is easy to see if light blocking is performed by a light control element. However, it is difficult to see if the motorcycle enters a tunnel because it is dark. For this reason, the light blocking ratio of the light control element is lowered to make it easy to see the outside.

In a case where it is detected that it is dark by the output of the illuminance sensor 118 during the light blocking by the light control element, if the deceleration of the motorcycle is detected, the light blocking ratio of the light control element is gradually lowered to allow the eyes to be familiar, so that it is possible to improve the display quality. If deceleration of the motorcycle is not detected, the light blocking ratio is instantaneously minimized to secure the field of view.

(7. Hardware Configuration)

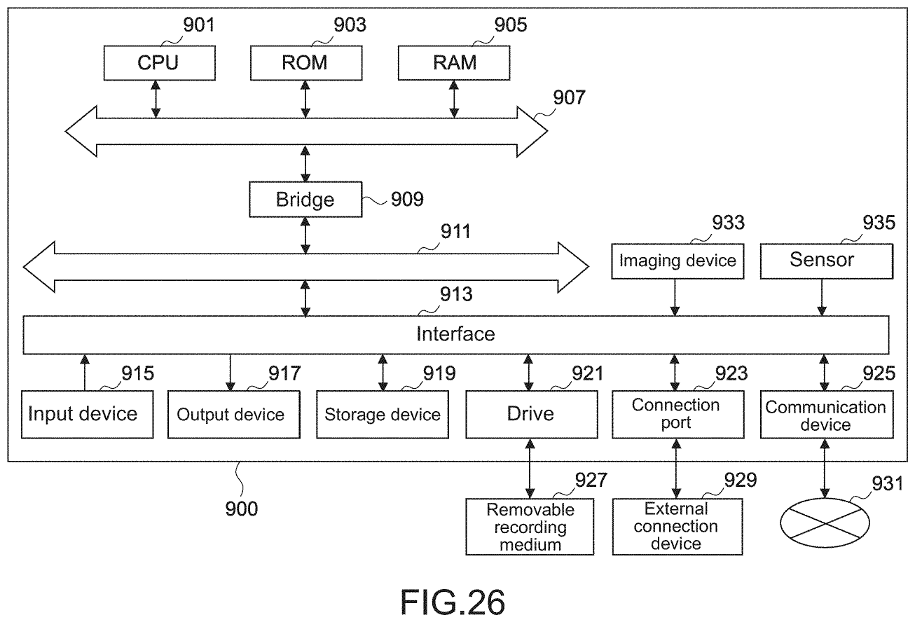

Next, a hardware configuration of an electronic apparatus according to an embodiment of the present disclosure will be described with reference to FIG. 26. FIG. 26 is a block diagram illustrating an example of the hardware configuration of the electronic apparatus according to the embodiment of the present disclosure. The illustrated electronic apparatus 900 can realize, for example, the see-through display device 100, the smartphone 200, and the server 300 in the above-described embodiment.

The electronic apparatus 900 includes a central processing unit (CPU) 901, a read only memory (ROM) 903, and a random access memory (RAM) 905. In addition, the electronic apparatus 900 may include a host bus 907, a bridge 909, an external bus 911, an interface 913, an input device 915, an output device 917, a storage device 919, a drive 921, a connection port 923, and a communication device 925. Furthermore, the electronic apparatus 900 may include an imaging device 933 and a sensor 935 as needed. The electronic apparatus 900 may have a processing circuit such as a digital signal processor (DSP) or an application specific integrated circuit (ASIC) instead of or in addition to the CPU 901.

The CPU 901 functions as an calculation processing unit and a control unit and controls all or a portion of the operations in the electronic apparatus 900 according to various programs recorded in the ROM 903, the RAM 905, the storage device 919, or the removable recording medium 927. The ROM 903 stores programs, calculation parameters, and the like used by the CPU 901. The RAM 905 primarily stores the programs used in the execution of the CPU 901, parameters that appropriately change in the execution, and the like. The CPU 901, the ROM 903, and the RAM 905 are connected to each other by the host bus 907 configured by an internal bus such as a CPU bus. Furthermore, the host bus 907 is connected to the external bus 911 such as a peripheral component interconnect/interface (PCI) bus via the bridge 909.

The input device 915 is, for example, a device operated by the user, such as a mouse, a keyboard, a touch panel, a button, a switch, and a lever. The input device 915 may be, for example, a remote control device using infrared rays or other radio waves or may be an external connection device 929 such as a mobile phone corresponding to the operation of the electronic apparatus 900. The input device 915 includes an input control circuit that generates an input signal on the basis of information input by the user and outputs the generated signal to the CPU 901. The user operates the input device 915 to input various data to the electronic apparatus 900 and instruct processing operations.

The output device 917 is configured with a device capable of visually or aurally notifying the user of the acquired information. The output device 917 may be, for example, a display device such as a liquid crystal display (LCD), a plasma display panel (PDP), an organic electro-luminescence (EL) display, an audio output device such as a speaker and a headphone, and a printer. The output device 917 outputs a result obtained by the processing of the electronic apparatus 900 as a text or a video such as an image or outputs the result as an audio such as audio or sound.

The storage device 919 is a device for data storage configured as an example of a storage unit of the electronic apparatus 900. The storage device 919 is configured with, for example, a magnetic storage device such as a hard disk drive (HDD), a semiconductor storage device, an optical storage device, or a magneto-optical storage device. The storage device 919 stores programs and various data executed by the CPU 901, various data acquired from the outside, and the like.

The drive 921 is a reader/writer for a removable recording medium 927 such as a magnetic disk, an optical disk, a magneto-optical disk, or a semiconductor memory and is built in or externally attached to the electronic apparatus 900. The drive 921 reads out the information recorded in the mounted removable recording medium 927 and outputs the information to the RAM 905. In addition, the drive 921 writes a record on the attached removable recording medium 927.

The connection port 923 is a port for directly connecting the device to the electronic apparatus 900. The connection port 923 may be, for example, a universal serial bus (USB) port, an IEEE 1394 port, a small computer system interface (SCSI) port, or the like. In addition, the connection port 923 may be an RS-232C port, an optical audio terminal, a high-definition multimedia interface (HDMI (registered trademark)) port, or the like. By connecting the external connection device 929 to the connection port 923, various data can be exchanged between the electronic apparatus 900 and the external connection device 929.

The communication device 925 is, for example, a communication interface configured as a communication device or the like for connecting to the communication network 931. The communication device 925 may be, for example, a communication card for a wired or wireless local area network (LAN), Bluetooth (registered trademark), or WUSB (Wireless USB). In addition, the communication device 925 may be a router for optical communication, a router for asymmetric digital subscriber line (ADSL), or a modem for various communications. The communication device 925 transmits and receives signals and the like to and from the Internet or another communication device by using a predetermined protocol such as TCP/IP. The communication network 931 connected to the communication device 925 is a network connected by wire or wireless and is, for example, the Internet, a home LAN, infrared communication, radio wave communication, satellite communication, or the like.

The imaging device 933 is a device that captures an image of a real space by using, for example, an imaging element such as a charge coupled device (CCD) or a complementary metal oxide semiconductor (CMOS), and various members such as lenses for controlling the formation of an object image on the imaging element and generates a captured image. The imaging device 933 may capture a still image or may capture a moving image.

The sensor 935 is, for example, various sensors such as an acceleration sensor, a gyro sensor, a geomagnetic sensor, an optical sensor, and a sound sensor. The sensor 935 acquires information on the state of the electronic apparatus 900 itself such as information on the posture of the housing of the electronic apparatus 900 and information on the surrounding environment of the electronic apparatus 900 such as brightness and noise around the electronic apparatus 900. In addition, the sensor 935 may include a GPS sensor that receives a global positioning system (GPS) signal to measure the latitude, longitude, and altitude of the device.

Heretofore, the example of the hardware configuration of the electronic apparatus 900 has been described. Each of the components described above may be configured by using a general-purpose member or may be configured by hardware specialized for the function of each component. Such configuration may be changed as appropriate in a manner that depends on the level of technology when being implemented.

(8. Supplement)

The embodiments of the present disclosure may include, for example, an electronic apparatus, a system, a method executed by the electronic apparatus or the system as described above, a program for causing the electronic apparatus to function, and a non-transitory tangible medium in which the program is recorded.

Heretofore, the preferred embodiments of the present disclosure have been described in detail with reference to the accompanying drawings, but the technical scope of the present disclosure is not limited to such examples. It is obvious that those skilled in the art of the present disclosure can conceive of various changes or modifications within the scope of the technical idea disclosed in the claims, and it is obvious that these are within the technical scope of the present disclosure.

In addition, the effects described in the present specification are merely illustrative or exemplary and not limitative. That is, the technology according to the present disclosure can exhibit other effects apparent to those skilled in the art from the description of the present specification in addition to or instead of the effects described above.

Note that the present technology may also be configured as follows.

(1)

A see-through display device, including:

an error detection unit detecting an error; and

a display control unit controlling display of a see-through display on the basis of a detection result of the error detection unit.

(2)

The see-through display device according to (1), in which

the error detection unit detects a communication error between the see-through display device and an outside.

(3)

The see-through display device according to (1), in which

the error detection unit detects an error that has occurred in a module included in firmware.

(4)

The see-through display device according to (1), in which

the error detection unit detects a communication error between a plurality of modules included in firmware.

(5)

The see-through display device according to (1), in which

the error detection unit detects an error of hardware.

(6)

The see-through display device according to (1), in which

the error detection unit detects an error on an application.

(7)

The see-through display device according to (1), in which

the error detection unit detects a communication error between an application and firmware.

(8)

The see-through display device according to any one of (1) to (7), in which

the error detection unit determines a level of the error, and

the display control unit controls the display of the see-through display on the basis of the level of the error determined by the error detection unit.

(9)

The see-through display device according to (8), in which

the error detection unit adjusts a luminance of the see-through display on the basis of the level of the error determined by the error detection unit.

(10)

The see-through display device according to (8), in which

the error detection unit adjusts a transmittance of a light control element included in the see-through display on the basis of the level of the error determined by the error detection unit.

(11)

The see-through display device according to (8), in which

the error detection unit adjusts at least one of a position and a size of a displayed image on the see-through display on the basis of the level of the error determined by the error detection unit.

(12)

The see-through display device according to any one of the above (1) to (11), further including

a see-through display mounted on a user's head and arranged in front of user's eyes.

(13)

The see-through display device according to any one of the above (1) to (11), in which

the see-through display device is installed in a car or motorcycle.

(14)

A system including:

a see-through display device including a see-through display; and

an information processing device connected to the see-through display device,

the system including:

an error detection unit detecting an error; and

a display control unit controlling display of the see-through display on the basis of a detection result of the error detection unit.

(15)

The system according to (14), in which

the error detection unit detects a communication error between the see-through display device and the information processing device.

(16)

The system according to (14), in which

the error detection unit detects a communication error between an application operating on the see-through display device and an application operating on the information processing device.

(17)

The system according to (14), in which

the error detection unit detects a communication error between firmware of the see-through display device and a library of the information processing device.

(18)

A system, including:

a see-through display device including a see-through display;

a first information processing device connected to the see-through display device; and

a second information processing device connected to the first information processing device,

the system including:

an error detection unit detecting an error; and

a display control unit controlling display of the see-through display on the basis of a detection result of the error detection unit.

(19)

A program causing an information processing device to function as:

an error detection unit detecting an error; and

a display control unit controlling display of a see-through display on the basis of a detection result of the error detection unit.

(20)

An information processing method, including:

in an error detection unit, detecting an error; and

in a display control unit, controlling display of a see-through display on the basis of a detection result of the error detection unit.

### REFERENCE SIGNS LIST

10, 20, 30, 40 system
100 see-through display device
110 display unit
112 display
191 glass application
192 smartphone application
192 smartphone application
193 cloud application
194 SE firmware
195 SE library
196 SE library
1000 system
1001 error detection unit
1002 display control unit

1. A see-through display device, comprising:
an error detection unit detecting an error; and
a display control unit controlling display of a see-through display on a basis of a detection result of the error detection unit.

2. The see-through display device according to claim 1, wherein
the error detection unit detects a communication error between the see-through display device and an outside.

3. The see-through display device according to claim 1, wherein
the error detection unit detects an error that has occurred in a module included in firmware.

4. The see-through display device according to claim 1, wherein
the error detection unit detects a communication error between a plurality of modules included in firmware.

5. The see-through display device according to claim 1, wherein
the error detection unit detects an error of hardware.

6. The see-through display device according to claim 1, wherein
the error detection unit detects an error on an application.

7. The see-through display device according to claim 1, wherein
the error detection unit detects a communication error between an application and firmware.

8. The see-through display device according to claim 1, wherein
the error detection unit determines a level of the error, and
the display control unit controls the display of the see-through display on a basis of the level of the error determined by the error detection unit.

9. The see-through display device according to claim 8, wherein
the error detection unit adjusts a luminance of the see-through display on a basis of the level of the error determined by the error detection unit.

10. The see-through display device according to claim 8, wherein
the error detection unit adjusts a transmittance of a light control element included in the see-through display on a basis of the level of the error determined by the error detection unit.

11. The see-through display device according to claim 8, wherein
the error detection unit adjusts at least one of a position or a size of a displayed image on the see-through display on a basis of the level of the error determined by the error detection unit.

12. The see-through display device according to claim 1, further comprising
a see-through display mounted on a user's head and arranged in front of user's eyes.

13. The see-through display device according to claim 1, wherein
the see-through display device is installed in a car or a motorcycle.

14. A system including:
a see-through display device including a see-through display; and
an information processing device connected to the see-through display device,
the system comprising:
an error detection unit detecting an error; and
a display control unit controlling display of the see-through display on a basis of a detection result of the error detection unit.

15. The system according to claim 14, wherein
the error detection unit detects a communication error between the see-through display device and the information processing device.

16. The system according to claim 14, wherein
the error detection unit detects a communication error between an application operating on the see-through display device and an application operating on the information processing device.

17. The system according to claim 14, wherein
the error detection unit detects a communication error between firmware of the see-through display device and a library of the information processing device.

18. A system including:
a see-through display device including a see-through display;
a first information processing device connected to the see-through display device; and
a second information processing device connected to the first information processing device,
the system comprising:
an error detection unit detecting an error; and
a display control unit controlling display of the see-through display on a basis of a detection result of the error detection unit.

19. A program causing an information processing device to function as:
an error detection unit detecting an error; and
a display control unit controlling display of a see-through display on a basis of a detection result of the error detection unit.

20. An information processing method comprising:
in an error detection unit, detecting an error; and
in a display control unit, controlling display of a see-through display on a basis of a detection result of the error detection unit.
